(19) United States
(12) Patent Application Publication
(10) Pub. No.: US 2002/0167202 A1
(43) Pub. Date: Nov. 14, 2002

(54) Sunshade for a motor vehicle roof and motor vehicle roof with a movable cover

(75) Inventor: Manfred Pfalzgraf, Herrsching (DE)

Correspondence Address: NIXON PEABODY, LLP, 8180 GREENSBORO DRIVE, SUITE 800, MCLEAN, VA, 22102, US

(73) Assignee: Webasto Vehicle Systems International GmbH, Stockdorf (DE)

(21) Appl. No.: 10/084,624

(22) Filed: Feb. 28, 2002

(30) Foreign Application Priority Data
Mar. 2, 2001 (DE) 201 03 710.6

(51) Int. Cl. B60J 7/043; B60R 21/22

(52) U.S. Cl. 296/214; 296/189; 280/730.1; 296/216.01

(57) ABSTRACT

A sunshade positioned under a motor vehicle roof and wound on a winding shaft in which the sunshade can be drawn by means of a draw bar guided on guides and can be positioned in different drawn positions. The draw bar is provided with a protective device that, in the event of a crash, mitigates the impact of a passenger against the draw bar. Additionally, an airbag is disclosed which is attached to the rear edge of the movable cover located in the roof opening of the motor vehicle roof so that in the event of a crash the impact of a passenger against the rear edge of the cover is reduced.

### BACKGROUND OF THE INVENTION

1. Field of the Invention

This invention relates to a sunshade wound on a winding shaft which is located under a motor vehicle roof and which can be drawn by means of a draw bar guided on guides and be positioned in different drawn positions. Further, the invention relates to a motor vehicle roof having a roof opening containing a movable cover which can be lowered to under a rear roof section and in doing so can be moved to the rear in the motor vehicle interior in order to clear the roof opening.

2. Description of the Related Art

German Patent DE 197 50 715 C1 discloses a shade device with two shades which can be drawn by a drive means for a transparent motor vehicle roof. The rear shade is located under the middle cross member of the motor vehicle roof and is drawn to the rear by means of a draw bar. In a crash situation, it is a possibility that a passenger sitting in the back in the motor vehicle could strike his/her head against the draw bar, which has been fixed in the drawn position, and in doing so could be injured.

Published German Patent Application DE 198 48 794 A1 discloses an airbag device where the airbag is located on the vehicle-mounted frame part of a sliding roof. In a motor vehicle having a cross member for the sliding roof, the airbag closes the sliding roof opening in case of a crash.

European Patent EP 0 734 894 B1 discloses a roof structure for a motor vehicle having a movable transparent roof section which can be lowered and can be moved to behind a rearward, rigid transparent roof section. Since the movable roof section can be moved underneath the rigid roof section without a covering to the motor vehicle interior, the rear edge of the movable roof section can constitute a source of danger in a crash situation to a passenger seated in the back who may strike the rear edge with his/her head.

German Patent 44 40 730 C1 has proposed improving the roof structure described in the above described publication by attaching a protective cover strip to the rear edge of the movable roof section which has a hinged strip area which is elastically pretensioned and which automatically raises itself when the roof section is lowered and covers the gap which forms between the movable and the rigid roof section.

### SUMMARY OF THE INVENTION

The primary object of the invention is to provide a sunshade for a motor vehicle roof which, in the case of a crash, the danger of injury to the passengers by the sunshade or by the movable cover is reduced.

This object is achieved by the present invention in which a sunshade draw bar is provided with a protection means that, in case of a crash, mitigates the impact of a passenger against the draw bar. The protection means of the invention provides a reduced risk of injury by a passenger striking the draw bar which is composed of a comparatively hard plastic or metal.

Preferably, the protective means contains an overload safety feature which upon impact enables the draw bar to yield or give. Thus, a protective function is easily achieved. The overload safety feature can be for example scoring which is formed on the draw bar, on the guide of the draw bar or on a drive means for the draw bar, or can be a detachable clip connection between the draw bar and the drive means, as an example.

According to one embodiment of the invention the overload safety feature of the draw bar is made deformable and flexible upon impact.

The overload safety feature can be an impact damping means for the draw bar. In this embodiment, the draw bar can be covered with a comparatively soft, yielding material. The impact damping means can also contain an air cushion or other cushion material such as rubber or hard foam and, particularly, an airbag means which inflates in case of an accident and which lies protectively in front of the draw bar.

Another embodiment has an airbag means along the length of the sunshade or at least in the area of the draw bar. For this embodiment, the length of shade can be made double-walled as a folded tubular length which is inflated when necessary.

The disclosed protective means can be used to particular advantage in a sunshade, which is located in the middle area of the motor vehicle roof and can be drawn out to the rear, in situations where a passenger, in a crash, sitting on a rear bench seat could collide with the draw bar. However, the protective means is also suited for sunshades which can be drawn to the front. The sunshade of the invention can be both manually drawn and can be operated by a drive means for drawing and retracting the length of shade.

These objects of the invention are achieved in the aforementioned motor vehicle roof in that the rear edge of the cover is provided a protective means which in case of a crash mitigates the impact of a passenger on the rear edge of the cover.

Preferably, the rear roof section is a fixed, transparent roof part, or a movable, transparent cover, which is located in the roof opening and under which the transparent front cover can be moved.

Preferably, the protective means contains an inflatable airbag means which covers the rear edge of the cover. The inflatable airbag can be contained in the cover frame on the rear edge of the cover or in a profile which is attached to the rear edge area of the cover. The profile can be opened when the airbag is inflated so that the airbag assumes a predetermined protective position on the rear edge of the cover.

The object of the invention can also be achieved by an inflatable airbag means in which the airbag is positioned on the rear edge of the movable cover located in the roof opening of the motor vehicle roof. Further, the movable cover can be lowered to clear the roof opening and move under a rear roof section, and in doing so is moved to the rear in the motor vehicle interior such that, in case of a crash, the impact of a passenger against the rear edge of the cover is avoided.

In addition, the object of the invention can be achieved by an airbag means in which the airbag is on the draw bar of a sunshade which is wound on a winding shaft and located under the motor vehicle roof. The sunshade can be drawn by means of the draw bar which is guided on guides and can be positioned in different drawn positions in order that, in case of a crash, the impact of a passenger against the draw bar is mitigated.

### BRIEF DESCRIPTION OF THE DRAWINGS

FIG. 1 shows a schematic lengthwise section of a motor vehicle roof with a front cover which can be lowered and moved to the rear and a sunshade means in the closed position;

FIGS. 2 to 6 show, in the same lengthwise view as FIG. 1, the cover and the sunshade means in different positions;

FIG. 7 is a perspective overhead view of the sunshade with a draw bar;

FIG. 8 shows, in an enlarged lengthwise section, the rearward end of the front cover with an airbag means; and

FIG. 9 shows, in an enlarged lengthwise section, the rearward end of the front cover with the airbag means activated;

FIG. 10 shows, in an enlarged lengthwise section, a draw bar with an impact damping means;

FIG. 11 shows, in an enlarged lengthwise section, the draw bar with an airbag means activated;

FIG. 12 shows, in a lengthwise cross section, a motor vehicle roof with two sunshade means constructed as airbag means that are in the inflated protective position;

FIG. 13 shows, in an enlarged lengthwise section, the rearward end of the rear sunshade with an airbag means; and

FIG. 14 shows, in an enlarged lengthwise section, the rearward end of the rear sunshade means with the airbag means activated.

### DETAILED DESCRIPTION OF THE INVENTION

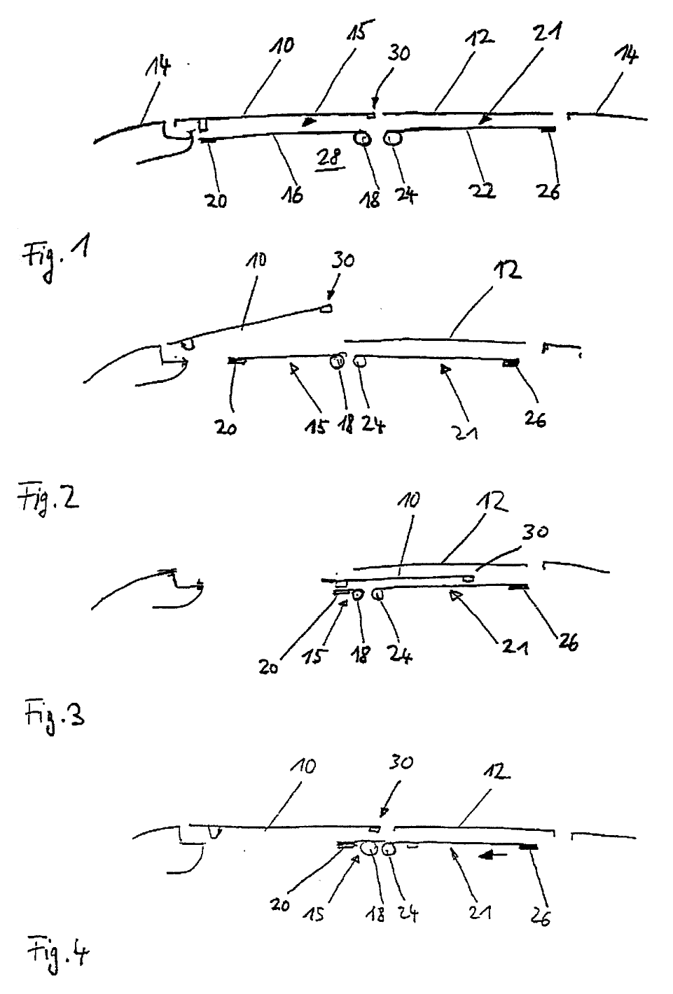

According to FIGS. 1 to 6, the motor vehicle roof includes two covers 10, 12 located one behind the other in the closed position (FIG. 1) and which close a common roof opening, or two roof openings separated by a middle crosspiece (not shown), in the fixed skin 14 of the motor vehicle roof in their closed position. Underneath the front cover 10, there is a front shade 15 which comprises a length 16 of shade which can be wound onto a winding shaft 18 that extends in the transverse direction of the roof and which is located in the area of the rearward end of the front cover 10. On the free end of the shade length 16, a draw bar 20 is attached. Similarly, underneath the rear cover 12 there is a rear shade 21 with a length 22 of shade, the winding shaft 24 being located adjacent and parallel to the winding shaft 18 of the front shade 15. The free rearward end of the length 22 of shade is also provided with a draw bar 26. The two covers 10 and 12 are made as transparent covers, preferably glass or plastic covers. The front shade 15 and the rear shade 21 are designed to at least partially cover the covers 10 and 12, respectively, and the roof opening, or roof openings, if necessary to prevent excess incident solar radiation in the motor vehicle interior 28.

The front shade 15 and the rear shade 21 are preferably constructed as in German Patent document 199 10 830 C1 which corresponds to U.S. patent application Ser. No. 09/524,539 (the entire disclosure of which is hereby incorporated by reference) as a shade with deflection rollers, the draw bar which is guided on lateral guides on both sides engaged by a cable which runs over the corresponding deflection rollers to the lateral edge area of the winding shaft, where it is wound and unwound. This construction of the shade has the advantage that the combination of the length of shade and cables is in equilibrium with and opposes a constant counter-force to displacement.

In the closed position shown in FIG. 1, the front shade 15 can also be moved manually in order to undertake the desired regulation of the incident solar radiation through the front cover 10.

The front cover 10 can be raised by means of a corresponding drive raising mechanism for the rear edge 30 and can be moved to the rear to under the rear cover 12 (FIG. 3) by means of a drive mechanism. The drive for the front cover 10 conventionally comprises at least one, and preferably two, compressively stiff drive cables which are driven via a pinion by an electric motor and each engage a slider of the cover adjustment mechanism.

FIG. 2 shows a position in which the front cover 10 is swiveled by means of a drive into the raised position for the rear cover edge 30. During this raising motion, the drive can automatically open the front shade 15 at least some distance, as is shown in FIG. 2, in order to enable air flow through the partially cleared roof opening in the swiveled cover 10. The drive mechanism can be made, for example, as in European Patent 0 150 470 B1 (the entire disclosure of which is hereby incorporated by reference) in which the free end of each drive cable can move the draw bar 20 of the front shade 15 to the rear by a driver means when the front cover 10 is being raised.

Alternatively, the drive mechanism can be made as in European Patent document 0 185 993 B1 (the entire disclosure of which is hereby incorporated by reference) in which the slider of the raising mechanism, which is engaged by the respective drive cable, is provided laterally with a rack which engages a gear arrangement mounted on the roof in the raising process and drives the roof to rotary motion, the gear arrangement in turn engaging the rack located laterally in the area of the draw bar 20 and in this way moves the draw bar 20 of the front shade 16 a limited distance to the rear into a partially open position as shown in FIG. 2.

In both of these embodiments, the front shade 15 and the draw bar 20 are blocked against a closing motion as long as the front cover 10 is raised.

The front cover 10 can be moved out of the position shown in FIG. 2 by lowering the rear edge 30 again into the closed position shown in FIG. 1, and, depending on the execution of the drive mechanism, the draw bar 20 can be automatically moved to the front in order to close the shade 15. The cover 10 can be pushed from the closed position of FIG. 1 to the rear under the rear cover 12 until the position shown in FIG. 3 is reached by lowering rear edge 30 of the cover 10 by means of a drive. This opening motion can be achieved by a drive means, as is shown in European Patent document 0 185 993 B1(the entire disclosure of which is hereby incorporated by reference), which also entrains the draw bar 20 and thus the length 16 of front shade 15 to the rear until the shade 15 has likewise been completely opened (FIG. 3).

With the front cover 10 open, the previously described process can proceed in the reverse sequence of motion so that the front cover 10 entrains the draw bar 20 forward into the closed position via the drive means.

The front shade 15 can be adjusted by the described embodiment of the drive for moving the front cover 10, at least in part automatically, to the corresponding opening of the shade. This increases the ease of operation, as compared to a purely manually opened shade, without an additional drive for the shade 15 being necessary.

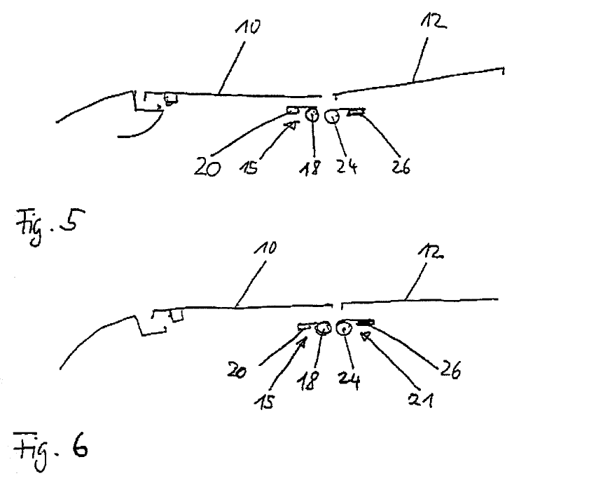

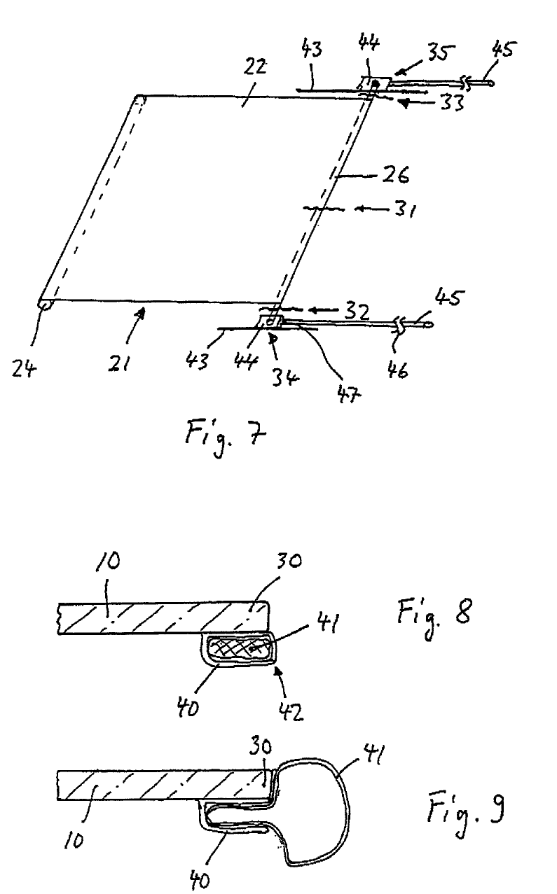

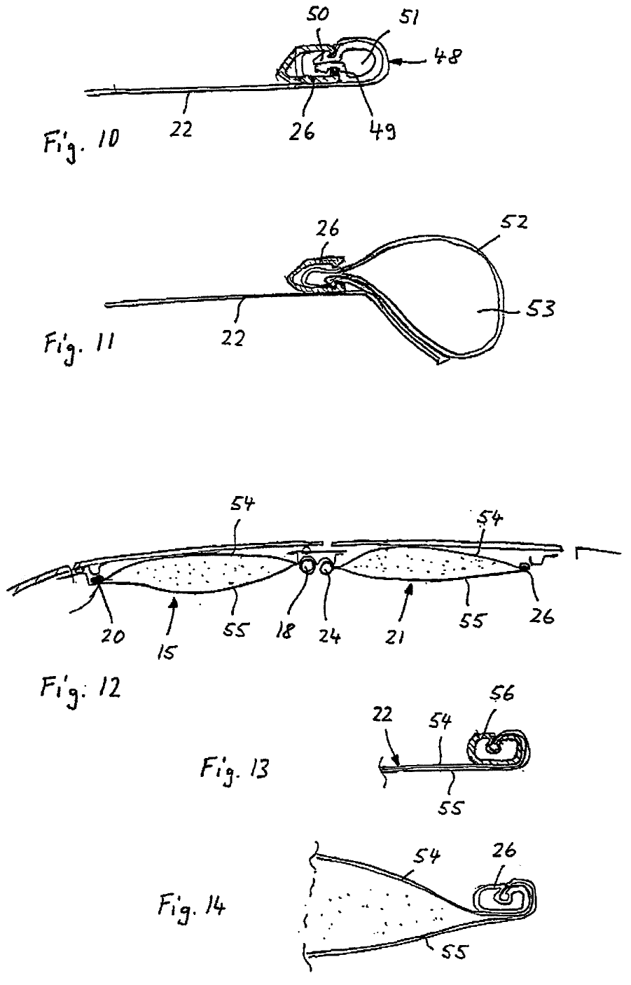

The rear cover 12 is only provided with a raising function, and is not provided with a sliding function. The rear cover 12 is driven by a second drive means which preferably comprises an electric motor which drives a pinion and two compressively stiff drive cables and which engage a slider of the cover mechanism. FIG. 4 shows a position in which the front cover 10 and the rear cover 12 are closed, while the front shade 15 is opened and the rear shade 21 is being opened to the front by being retracted by means of the second drive for raising the rear cover 12. In this sequence, there is a driver on the slider which moves the draw bar 26 of the rear shade 21. Before the rear shade 21 is completely opened, the drive motion of the slider does not cause actuation of the raising mechanism of the rear cover 12. When complete opening of the rear shade 21 is reached, the slider automatically disengages with respect to the draw bar 26, which is locked in the open position by means of a locking block. The operation of one such locking block is known, for example in German Patent documents 39 30 756 A1 or 40 01 759 C1 (the entire disclosures of which are hereby incorporated by reference). Thereafter, the slider engages the raising mechanism of the rear cover 12 which had previously been locked with the locking block and causes a raising motion of the rear cover 12, its rear edge being raised (see FIG. 5). When the cover 12 is lowered out of this position back into its closed position, the slider disengages from the raising mechanism of the cover 12, thereby locking of the cover 12 by means of the locking block. Then the slider again engages the draw bar 26, by which it is unlocked and is entrained in a closed position.

The draw bar 26 of the rear shade 21, which is formed for example as a rod-shaped element with a solid or hollow cross section, contains at least one scored site 31 (see FIG. 7 indicated by the wavy line) which is located, as an example, in the middle of the draw bar 26, and/or two scored sites 32 and 33 which are located, as an example, at the two edges of the draw bar 26 adjacent to the ends 34 and 35 of the draw bar 26 which are guided in the lengthwise guides 43 with sliders 44. The scored sites are designed such that a passenger who is sitting on a rear bench seat and who, in case of a crash, hits his/her head against the draw bar 26 positioned in the drawn position of the shade as shown in FIG. 1, or in the retracted position as shown in FIG. 6, or in an intermediate position, can cause deformation or breaking of the draw bar 26 so that the draw bar 26 gives and does not provide stationary resistance which can cause serious injury to the rear passenger. There can also be scored sites in the drive means for the draw bar 26, such as for example in a drive cable 45 (scored site 46), or on the attachment 47 of the drive cable 45 to the draw bar 26.

In an alternative embodiment, the draw bar 26 can be made flexible such that upon impact it deforms and thus reducing the risk of injury. To do this, the draw bar 26 can be made flexible over its entire length or in at least one certain section, such as for example in the middle section.

FIG. 8 shows an embodiment in which the rear section 30 of the front cover 10 is elongated, and is provided with a plastic hollow section 40 containing an airbag 41. The hollow section 40 contains a weakened area as the scored site 42 such that inflation of the airbag 41 causes the hollow section 40 to open at a defined location such that the airbag 41, in the inflated state, lies protectively in front of the rear edge 30 of the cover 10 (see FIG. 9). To inflate the airbag 41, the hollow section 40 contains a match cord (not shown) which generates propellant gas to inflate the airbag 41. In a crash, the vehicle passenger is protected against injury by the rear edge 30 of the lowered and opened cover 10.

The hollow section 40, with the airbag 41, can be positioned entirely or partially underneath the rear edge 30 of the cover 10, or can be positioned to surround the rear edge 30, or constructed as part of a rear cover seal.

FIG. 10 shows the draw bar 26 of the rear sunshade 21 which has an impact attenuation means in the form of a lengthwise element 48 which is clipped on a slot 49 of the open section of the draw bar 26 and is held with barbs 50. The element 48 contains a chamber 51 which is filled with air or a damping material, for example, rubber or plastic foam. Alternatively, the element 48 is an airbag 52 with a hollow chamber 53 which can be filled by means of a compressed gas so that the airbag 52 deploys into a protective position when inflated (see FIG. 11).

FIG. 12 illustrates a motor vehicle roof with a sun protection means in the form of two sunshades, the lengths of which are airbags, and which are shown in the filled protective position. Each sunshade 15, 21 contains an upper length of material 54 and a lower length of material 55 which lie one on top of the other and are anchored on the draw bar 20, 26 (FIG. 13). When the airbag is triggered, the expanding gases are fed, for example, via the draw bar 20, 26 (FIG. 14) to which a gas unit is connected.

What is claimed is:

1. A sunshade device adapted for mounting under a motor vehicle roof, comprising a sunshade, one end of the sunshade is attached to a winding shaft around which the sunshade is windable and another end of which has a draw bar attached for guiding the sunshade during opening and closing movement along guides, wherein the draw bar is provided with a protective means which is adapted, in a crash situation, to protect a rear seat passenger during impact with the draw bar.

2. A sunshade as set forth in claim 1, wherein the protective means comprises an overload safety feature which, upon impact, enables the draw bar to yield or break.

3. A sunshade as set forth in claim 2, wherein the overload safety feature includes at least one scored site.

4. A sunshade as set forth in claim 3, wherein the scored site is formed on one of the draw bar, a guide of the draw bar, and a drive means for the draw bar.

5. A sunshade as set forth in claim 1, wherein the protective means comprises an overload safety feature which includes the draw bar being constructed to deform or flexi upon impact.

6. A sunshade as set forth in claim 1, wherein the protective means is an impact damping means on the draw bar.

7. A sunshade as set forth in claim 6, wherein the impact damping means includes a gas cushion means.

8. A sunshade as set forth in claim 1, wherein the sunshade is constructed to include a gas cushion.

9. A sunshade as set forth in claim 1, wherein the sunshade is constructed as a gas cushion.

10. A sunshade as set forth in claim 1, wherein the sunshade is located in a middle area of the motor vehicle roof and is adapted to be drawn to the rear.

11. A sunshade as set forth in claim 1, wherein the sunshade is connected to a drive for opening and closing the shade.

12. A motor vehicle roof including a roof opening and a movable cover capable of being lowered to a position underneath a rear roof section and moved toward the rear of the motor vehicle,
wherein a rear edge of the cover includes a protective means which is adapted, in a crash situation, to protect a rear seat passenger during impact with a rear edge of the cover.

13. The motor vehicle roof of claim 12, further including a rear roof section located in the roof opening and under which the cover is adapted to be moved.

14. The motor vehicle roof of claim 12, wherein the protective means includes an inflatable airbag on the rear edge of the cover.

15. The motor vehicle roof of claim 14, wherein the inflatable airbag is located in a cover frame on the rear edge of the cover.

16. The motor vehicle roof of claim 14, wherein the inflatable airbag is located in a profile attached to the rear edge area of the cover.

17. The motor vehicle roof of claim 12, further comprising a sunshade located under the motor vehicle roof which is attached on one end to a winding shaft around which the sunshade windable and at another end has a draw bar attached for guiding the sunshade along guides during opening and closing movements, wherein the draw bar is provided with protective means which is adapted, in a crash situation, to protect a rear seat passenger during impact with the draw bar..

18. An airbag arrangement located in an opening in a roof of a motor vehicle, comprising an airbag mounted on a rear edge of a movable cover adapted to be mounted in the roof opening of the motor vehicle roof such that the cover can be lowered to clear the roof opening and moved to a rearward position under a rearward roof section, wherein the airbag means is adapted, in a crash situation, to protect a rear seat passenger during impact with the rear edge of the movable cover.

19. An airbag arrangement located underneath an opening in a roof of a motor vehicle, comprising a sunshade positioned underneath the roof opening, a winding shaft around which the sunshade is windable, guides for the sunshade for guiding the movement of the sunshade to different drawn positions, a draw bar mounted on a rearward edge of the sunshade, and an airbag attached to the draw bar, wherein the airbag is adapted, in a crash situation, to protect a rear seat passenger during impact with a rearward edge of the draw bar.

20. A sunshade as set forth in claim 2, wherein the overload safety feature includes at least one detachable clip connection.

21. A sunshade as set forth in claim 3, wherein the at least one score site comprises multiple scored sites formed on one of the draw bar, a guide of the draw bar, and a drive means for the draw bar.

22. A sunshade as set forth in claim 21, wherein the multiple scored sites are formed on the draw bar.
